(19) United States
(12) Patent Application Publication
(10) Pub. No.: US 2002/0124091 A1
(43) Pub. Date: Sep. 5, 2002

(54) Network service setting system, network service providing method and communication service

(76) Inventors: Yoshitoshi Kurose, Kawasaki (JP); Jun Ogawa, Kawasaki (JP)

Correspondence Address: Rosenman & Colin LLP, 575 Madison Avenue, New York, NY, 10022-2585, US

(21) Appl. No.: 09/957,148

(22) Filed: Sep. 20, 2001

(30) Foreign Application Priority Data
Mar. 1, 2001 (JP) 2001-056400

(51) Int. Cl. G06F 15/16; G06F 15/173

(52) U.S. Cl. 709/228; 709/238

(57) ABSTRACT

A service setting system, a network service providing method and a communication service, in which in making a communication via a network, a service condition of a network resource contained in individual communication device is set up so that the network service corresponding to the whole communication path intended for the communication meets a predetermined request is disclosed.

### BACKGROUND OF THE INVENTION

The present invention is directed to a network service setting system, a network service providing method and a communication service in which a predetermined network service is provided in the transfer path.

Generally, when a network device such as a communication terminal makes a request to the network for a service of quality assurance or security, a signaling protocol is employed.

FIG. 23 is a block diagram showing the configuration of a network including the routing apparatuses. The network as shown in FIG. 23 makes a predetermined communication between a communication terminal 900 and a communication terminal 902, which are connected via a plurality of (e.g., three) routing apparatuses 910, 912 and 914. Also, this network provides a service using the signaling protocol in accordance with the following procedure.

1. Communication terminal 900 transmits a path finding signaling packet to a routing apparatus 910 (A). Each of routing apparatuses 910, 912, 914 transmits the path finding signaling packet hop by hop to reach the communication terminal 902 (B, C, and D). Also, each of routing apparatuses 914, 912, 910 memorizes the name of a routing apparatus that transmits the path finding signaling packet, and thereby a route through which the data is relayed, in transferring the path finding signaling packet.

2. Communication terminal 902 transmits a service request signaling packet based on a service request stored externally or internally to the routing apparatus 914.

3. The routing apparatus 914 that has received the service request signaling packet performs a service setting possibility judgement for judging whether or not there is any available resource that is necessary to provide a service. If service setting is possible, the routing apparatus 914 makes the service setting, and then transfers the service request signaling packet to the next routing apparatus 912.

4. The routing apparatus 912 that has received the service request signaling packet performs a service setting possibility judgement for judging whether or not there is any available resource that is necessary to provide the service. If service setting is possible, the routing apparatus 912 makes the service setting, and then transfers the service request signaling packet to the next routing apparatus 910.

5. The routing apparatus 910 that has received the service request signaling packet performs a service setting possibility judgement for judging whether or not there is any available resource that is necessary to provide the service. If service setting is possible, the routing apparatus 910 makes the service setting, and then transfers the service request signaling packet to the next communication terminal 900.

6. In this way, after various service settings for providing the service requested by the communication terminal 902 are made by the routing apparatuses 914, 912 and 910, the service request signaling packet arrives at the communication terminal 900. Thereby, the communication terminal 900 is enabled to provide the service.

By the way, with the conventional method as set forth above, each of the routing apparatuses 910 through 914 residing on the communication path makes respective setting to meet the request to implement the network service with the communication terminal 900. However, even when each of the routing apparatuses 910 through 914 makes the setting to meet the request, the request may not be met in the communication path as a whole, depending on the network service. A specific example thereof will be set forth below.

In Case of Preferring Less Discard

First of all, consider an instance that each of the routing apparatuses 910 through 914 makes the setting taking preference of suppressing the discard.

FIG. 24 is a block diagram showing the set contents of each routing apparatus when taking preference of suppressing the discard. Herein it is supposed that each routing apparatus allows for a delay assurance setting of 1 msec to 5 msec. Also, it is supposed that each routing apparatus uses the setting of a queue length for making the delay assurance, and the discard ratio of packet increases as the delay assurance is a smaller set value.

1. Communication terminal 900 sends out a path finding signaling packet. When the path finding signaling packet arrives at the communication terminal 902, a route for providing the service is determined (A, B, C and D).

2. The communication terminal 902 transmits a service request signaling packet with the service request content of “service for suppressing communication delay to 10 msec” to the routing apparatus 914 (E).

3. The routing apparatus 914 that has received the service request signaling packet, after making the service providing setting to assure a request delay, transfers the service request signaling packet received from the communication terminal 902 to the next routing apparatus 912 (F). At this time, the routing apparatus 914 has a delay assurance setting of 5 msec as a value to suppress the packet discard and assure the request delay, and the delay permissible for other routing apparatuses 910, 912 is 5 msec in total. Therefore, the routing apparatus 914 changes the content of service request within the signaling packet to “service for suppressing the communication delay to 5 msec”.

4. The routing apparatus 912 that has received the service request signaling packet, after making the service providing setting to assure a request delay, transfers the service request signaling packet received from the communication terminal 902 to the next routing apparatus 910 (G). At this time, the routing apparatus 910 has a delay assurance setting of 5 msec as a value to suppress the packet discard and assure the request delay, and the delay permissible for remaining routing apparatus 910 is 0 msec. Therefore, the routing apparatus 912 changes the contents of service request within the signaling packet to “service for suppressing the communication delay to 0 msec”.

5. The routing apparatus 910 that has received the service request signaling packet attempts to make the setting corresponding to the service request. However, the “service for suppressing the communication delay to 0 msec” is impossible. As a consequence, the service requested by the communication terminal 912 becomes impossible to provide in the routing apparatus 910.

6. With the above discussion, the service requested by the communication terminal 902 becomes impossible to provide in the routing apparatuses 910 through 914.

In case of preferring delay assurance Consider an instance that each of the routing apparatuses 910 through 914 makes the setting taking preference of the delay assurance.

FIG. 25 is a block diagram showing the set contents of each routing apparatus when taking preference of the delay assurance. Herein it is supposed that each routing apparatus allows for a delay assurance setting of 1 msec through 5 msec. Also, it is supposed that each routing apparatus uses the setting of a queue length to make the delay assurance, and the discard ratio of packet increases as the delay assurance is a smaller set value.

1. Communication terminal 900 sends out a path finding signaling packet. When the path finding signaling packet arrives at the communication terminal 902, a route for providing the service is determined (A, B, C and D).

2. Communication terminal 902 transmits a service request signaling packet with the service request content of “service for suppressing communication delay to 10 msec” to the routing apparatus 914 (E).

3. The routing apparatus 914 that has received the service request signaling packet, after making the service providing setting to assure a request delay, transfers the service request signaling packet received from the communication terminal 902 to the next routing apparatus 912 (F). At this time, the routing apparatus 914 has a delay assurance setting of 1 msec as a value to assure the request delay, and the delay permissible for other routing apparatuses 910, 912 is 9 msec in total. Therefore, the routing apparatus 914 changes the content of service request within the signaling packet to “service for suppressing the communication delay to 9 msec”.

4. Routing apparatus 912 that has received the service request signaling packet, after making the service providing setting to assure the request delay, transfers the service request signaling packet received from the communication terminal 902 to the next routing apparatus 910 (G). At this time, the routing apparatus 912 has a delay assurance setting of 1 msec as the value to assure the request delay, and the delay permissible for remaining routing apparatus 910 is 8 msec. Therefore, the routing apparatus 912 changes the content of service request within the signaling packet to “service for suppressing the communication delay to 8 msec”.

5. Routing apparatus 910 that has received the service request signaling packet, after making the service providing setting to assure the request delay, transfers the service request signaling packet received from the communication terminal 902 to the next device, that is, the communication terminal 900 (H). At this time, the routing apparatus 910 has a delay assurance setting of 1 msec as the value to assure the request delay, and the delay permissible for remaining device is 7 msec. Therefore, the routing apparatus 910 changes the content of service request within the signaling packet to “service for suppressing the communication delay to 7 msec”. In this way, as a result of the delay assurance performed by each routing apparatus, the request delay designated by the communication terminal 902 is assured.

6. However, since the maximum delay assurance setting is made in each routing apparatus, the packet discard ratio in each routing apparatus increases. This indicates that no appropriate setting is made for the service to suppress the discard and make the delay assurance. As a consequence, there is the problem that the service is not appropriately provided.

### SUMMARY OF THE INVENTION

The present invention has been achieved in the light of the above problem, and it is an object of the invention to provide a service setting system, a network service providing method and a communication service in which a network service request can be met throughout a communication path.

A network service setting system of the invention comprises a communication device and a setting generation device. The communication device has a network resource for providing a predetermined network service in making the communication via a network. Also, the setting generation device sets up the service conditions of the network resources contained in individual communication devices so that the network service corresponding to the whole communication path intended for this communication meets a predetermined request. Since the service condition of the network resource contained in each communication device is synthetically managed and set up by the setting generation device, it is possible to meet a desired network service request throughout the communication path.

In the case where the communication device is a routing apparatus connecting between terminal devices for transmitting and receiving the data through communication, this routing apparatus desirably comprises an information transfer section for notifying its own resource information to the setting generation device, and a network service providing section for providing a network service of the content based on the setting information passed from the setting generation device. Since each routing apparatus itself notifies its own resource information to the setting generation device, the setting generation device can grasp the content of resource for each routing apparatus contained in the whole communication path.

Also, the setting generation device desirably comprises an information collection section for collecting the resource information passed from the routing apparatus, a setting information generation section for generating the setting information on the basis of the resource information corresponding to a plurality of routing apparatuses which the information collection section collects, and a setting information transmission section for transmitting the setting information to the routing apparatus. The setting generation device can set up the appropriate setting information required to meet a network service request by collecting the resource information passed from each routing apparatus and transmit it to each routing apparatus.

Preferably, the setting generation device further comprises a contention judgement section for judging the contention of request in accordance with a predetermined rule. By avoiding the contention of request, it is possible to provide a network service that can meet the request content for some request reliably.

In the case where the setting generation device further comprises a load management section for managing the load state of routing apparatus, the setting information generation section preferably generates the setting information in consideration of the load state managed by this load management section. Thereby, it is possible to make effective use of the resource for each routing apparatus by taking into consideration the load state of each routing apparatus, and provide an efficient network service.

Also, the routing apparatus further comprises a preliminary setting section for making the preliminary setting of the contents of network service, before setting the content of network service on the basis of the setting information passed from the setting generation device, and it is preferred that the network service providing section starts the network service in accordance with the content of the preliminary setting. Since the routing apparatus makes the preliminary setting of the contents of network service, the processing load can be relieved when the setting generation device sets up the content of setting information. Also, since the network service can be started to provide when the preliminary setting has been made, the time till the start of providing the network service can be shortened.

Also, the information transfer section is a signaling processing section for transmitting and receiving a signaling packet in accordance with a resource reservation protocol, and it is preferred that the notification of resource information is made employing a path message. Since the notification of resource information can be made at the same time of finding the path, the resource information can be transmitted to the setting generation device without transmitting or receiving a special signal.

Also, the setting information transmission section is a signaling processing section for transmitting and receiving the signaling packet in accordance with a resource reservation protocol, and it is preferred that the setting information is transmitted employing a reservation message. Since the reservation message is required to return when a path message is transmitted, the setting of each routing apparatus can be securely effected by containing the setting information in this path message.

In a network service providing method of this invention for providing a predetermined network service in making the communication via a network, at a first step, the setting generation device sets up the service condition of the network resource contained in individual communication device so that the network service corresponding to the whole communication path intended for this communication meets a predetermined request. At a second step, a predetermined network service is provided in individual communication device for which the service condition of the network resource is set up at the first step. Since the service condition of the network resource contained in each communication device is synthetically managed and set up, it is possible to meet a desired network service request throughout the communication path.

It is preferable that individual communication device has a third step of notifying its own resource information to the setting generation device, before the first step. Since each communication device notifies its own resource information, the setting generation device can grasp the contents of resources for a plurality of communication devices residing on the communication path.

Also, it is preferable that the service condition of the network resource at the first step is set up in consideration of the load state of individual communication device. Thereby, it is possible to make effective use of the resource for each communication device by taking into consideration the load state of each communication device, and provide an efficient network service.

The communication service of the invention provides a network service which can meet a predetermined request throughout the communication path employing a plurality of communication devices by collecting and managing synthetically the information of network resource for individual communication device. The network service corresponding to the whole communication path can meet a predetermined request by managing, and setting up synthetically the network resources for individual communication devices, but not separately setting up the network resources of individual communication devices, and provide an efficient network management.

### BRIEF DESCRIPTION OF THE DRAWINGS

FIG. 1 is a block diagram showing a configuration of a network according to a first embodiment of the present invention;

FIG. 2 is a block diagram showing a schematic configuration of a routing apparatus;

FIG. 3 is a block diagram showing a schematic configuration of a setting generation device;

FIG. 4 is a flowchart showing an operation procedure of the routing apparatus receiving a path finding signaling packet;

FIG. 5 is a diagram showing the contents of the path finding signaling packet that is transmitted or received via the routing apparatus;

FIG. 6 is a flowchart showing the operation procedure of the setting generation device;

FIG. 7 is a table showing the contents of a resource management database;

FIG. 8 is a flowchart showing the operation procedure of the routing apparatus receiving a service request signaling packet;

FIG. 9 is a block diagram showing the contents of the service request signaling packet that is transmitted or received via the routing apparatus and the set contents at the routing apparatus;

FIG. 10 is a block diagram showing the configuration of a setting generation device included in a network according to a second embodiment of the invention;

FIG. 11 is a block diagram showing the configuration of a setting generation device included in a network according to a third embodiment of the invention;

FIG. 12 is a table showing the contents of a status management database;

FIG. 13 is a diagram showing the contents of the path finding signaling packet that is transmitted or received via the routing apparatus;

FIG. 14 is a block diagram showing the contents of the service request signaling packet that is transmitted or received via the routing apparatus and the set contents at the routing apparatus;

FIG. 15 is a block diagram showing the configuration of a network according to a fourth embodiment of the invention;

FIG. 16 is a block diagram showing the schematic configuration of a setting generation device;

FIG. 17 is a block diagram showing the schematic configuration of a routing apparatus;

FIG. 18 is a block diagram showing the schematic configuration of a communication terminal;

FIG. 19 is a block diagram showing the contents of the path finding signaling packet that is transmitted or received via the routing apparatus at the time of routing;

FIG. 20 is a block diagram showing the contents of the service request signaling packet that is transmitted or received via the routing apparatus and the set contents at the routing apparatus;

FIG. 21 is a table showing the contents of a resource management database;

FIG. 22 is a block diagram showing the contents of the path finding signaling packet that is transmitted or received via the routing apparatus and the set contents at the routing apparatus;

FIG. 23 is a block diagram showing the configuration of a network including the routing apparatuses;

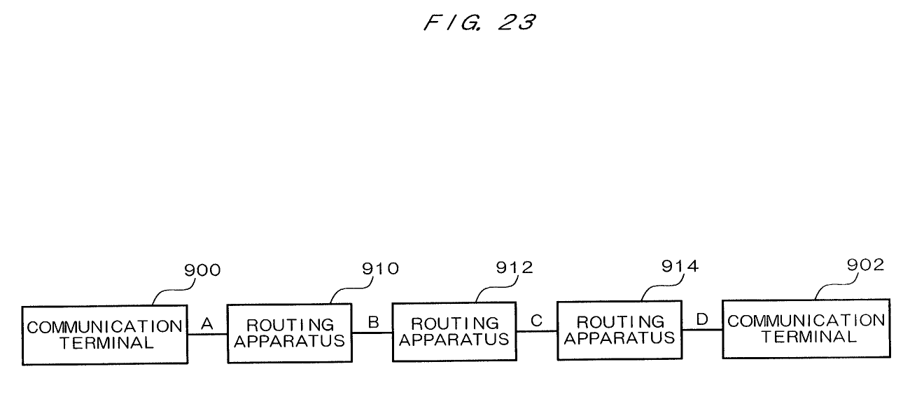

FIG. 24 is a block diagram showing the set content of each routing apparatus when taking preference of suppressing the discard; and

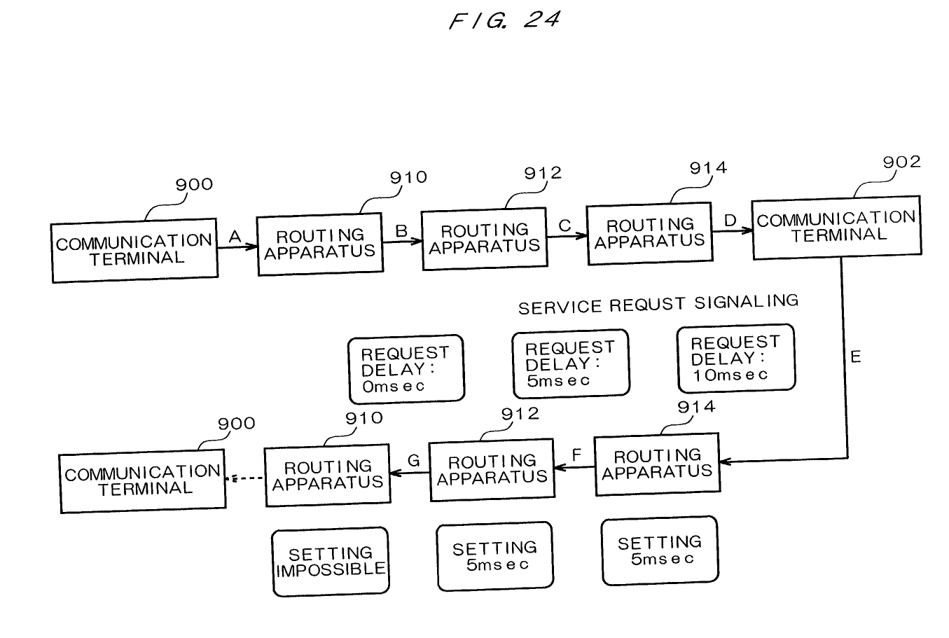

FIG. 25 is a block diagram showing the set content of each routing apparatus when taking preference of the delay assurance.

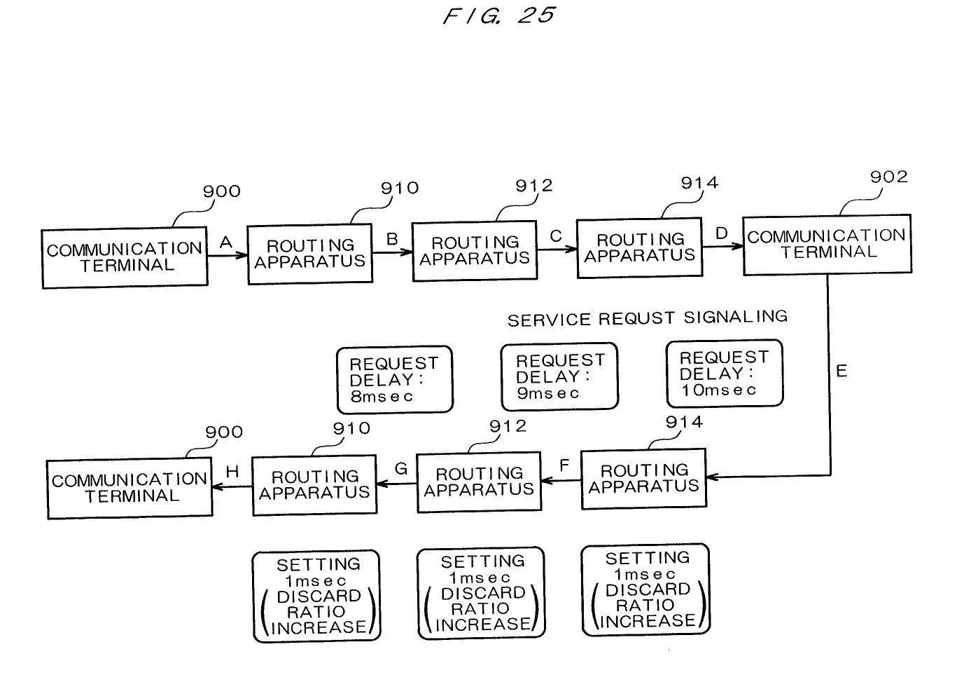

### DESCRIPTION OF THE PREFERRED EMBODIMENTS

A network according to one embodiment of the present invention will be described below with reference to the accompanying drawings.

[First Embodiment]

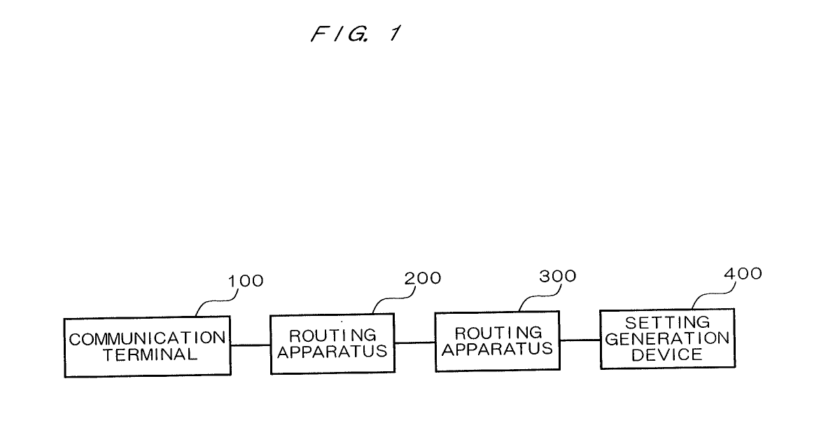

FIG. 1 is a block diagram showing a configuration of a network according to a first embodiment of the invention. As shown in FIG. 1, the network of this embodiment comprises a communication terminal 100, the routing apparatuses 200, 300, and a setting generation device 400. This network is an IP network in which an IP packet is used as a data packet, and can communicate various kinds of data in accordance with the TCP (Transmission Control Protocol)/IP as a communication protocol, for example. Also, setting a path between the communication terminal 100 and the setting generation device 400 and a request for a network service in making the communication via this path can be effected by transmitting a signaling packet containing an RSVP (Resource Reservation Protocol) message.

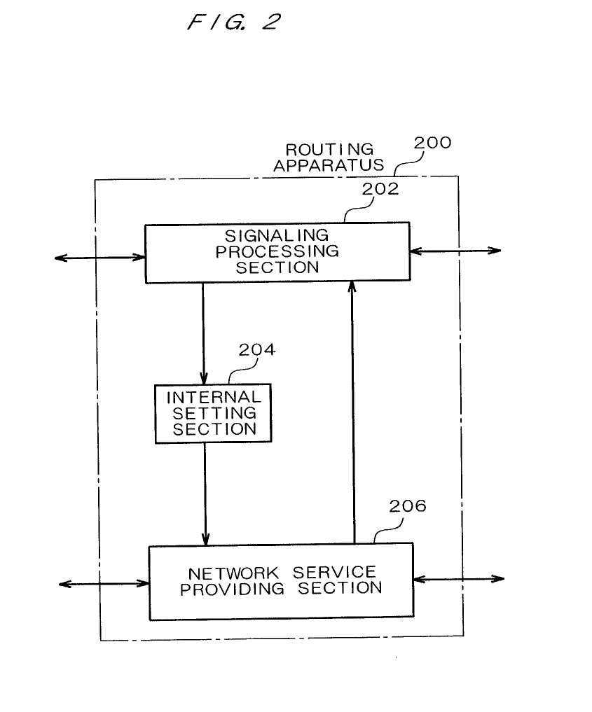

FIG. 2 is a block diagram showing a schematic configuration of a routing apparatus 200. As shown in FIG. 2, the routing apparatus 200 comprises a signaling processing section 202, an internal setting section 204, and a network service providing section 206.

The signaling processing section 202 performs the signaling processing employing the RSVP message. Specifically, the signaling processing section 202 transmits a path finding signaling packet to determine a route through which a network service is provided. Also, the signaling processing section 202 receives a service request signaling packet sent back corresponding to this path finding signaling packet. For example, in the RSVP, the path finding signaling packet is constructed employing a path message, and the service request signaling packet is constructed using a reservation message. This signaling processing section 202 operates as an information transfer section to notify the resource information and function information provided in the routing apparatus 200 and the information for providing the network service that the routing apparatus 200 performs, to the outside.

The internal setting section 204 sets the contents of a network service to be provided for the network service providing section 206, when a service request signaling packet is received by the signaling processing section 202.

The network service providing section 206 provides the network service of the set contents, upon an instruction from the internal setting section 204. For example, the maximum delay time permissible to transmit or receive the packet via this routing apparatus 200 or the communication band can be set by the network service providing section 206.

A routing apparatus 300 (signaling processing section 302, internal setting section 304, network service providing section 306) and the communication terminal 100 (signaling processing section 102, internal setting section 104, network service providing section 106) have fundamentally the same configuration, in which like parts are designated by the same or like reference numerals, and not described in detail.

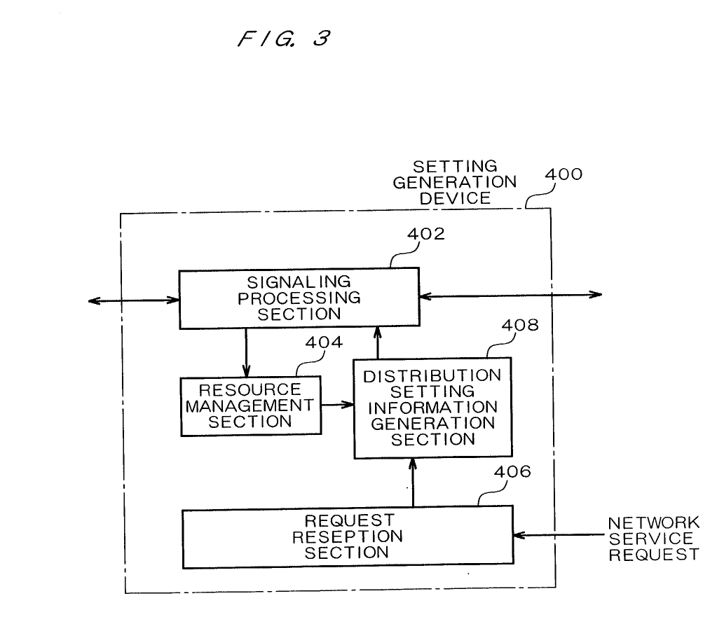

FIG. 3 is a block diagram showing the schematic configuration of the setting generation device 400. As shown in FIG. 3, the setting generation device 400 comprises a signaling processing section 402, a resource management section 404, a request reception section 406, and a distribution setting information generation section 408. In this embodiment, the communication terminal 100 transmits or receives a packet to or from the setting generation device 400 connected via the routing apparatuses 200 and 300. That is, this setting generation device 400 has a communication function similar to that of the communication terminal 100. In other words, it is supposed in this embodiment that some other communication terminal that is a communication partner of the communication terminal 100 also has the function of the setting generation device 400.

The signaling processing section 402 performs the signaling processing employing the RSVP message. Specifically, the signaling processing section 402 forwards a service request signaling packet containing the setting information (hereinafter described) to the routing apparatus 300, if receiving a path finding signaling packet from the signaling processing section 302 within the routing apparatus 300. This signaling processing section 402 operates as an information collection section for receiving various kinds of information transmitted from each routing apparatus 200, 300, as well as a setting information transmission section to notify the setting information to each routing apparatus 200, 300.

The resource management section 404 collects the information of each routing apparatus 200, 300 contained in the path finding signaling packet received by the signaling processing section 402, and manages synthetically the network resource that each routing apparatus 200, 300 has.

The request reception section 406 accepts a network service request corresponding to the packet communication between the communication terminal 100 and the setting generation device 400. This network service request is either transmitted from the outside or stored within the request reception section 406.

The distribution setting information generation section 408 generates the setting information regarding the network resource of each routing apparatus 200, 300 required to implement the requested network service, on the basis of the information regarding the network resource of each routing apparatus 200, 300 collected by the resource management section 404 and the content of network service request accepted by the request reception section 406. For example, in the case where the network service request contains the maximum delay time occurring when routed via the routing apparatuses 200 and 300, the delay time permissible in each routing apparatus 200, 300 is generated as the setting information.

The communication terminal 100, the routing apparatuses 200, 300, and the setting generation device 400 of this embodiment have the above configuration. The operation thereof will be described below. For example, when communicating a packet from one communication terminal 100 to the setting generation device 400 as the other terminal device, consider a case of providing a network service for setting the total delay time in two routing apparatuses 200 and 300 below a predetermined set value.

Operation of Routing Apparatus (at the Time of Routing)

The operation of each routing apparatus 200, 300 at the time of routing, employing a path finding signaling packet will be described below.

The communication terminal 100 for transmitting the data (packet) that is intended for providing a network service generates a path finding signaling packet in the signaling processing section 102, and transmits it to the routing apparatus 200 at the subsequent stage. The routing apparatus 200 receives this path finding signaling packet and performs the following operation.

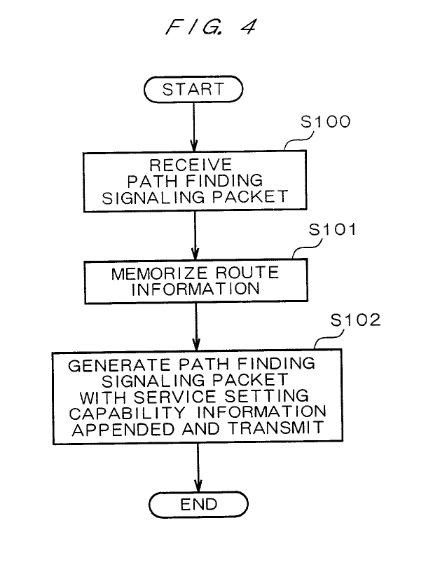

FIG. 4 is a flowchart showing the operation procedure of the routing apparatus 200 that has received the path finding signaling packet. The signaling processing section 202 within the routing apparatus 200 receives the path finding signaling packet (step S100), and then memorizes a network device (communication terminal 100) corresponding to a transmission source address contained in this packet as a part of the route information (step S101). Then, the signaling processing section 202 acquires the service setting capability information of the routing apparatus 200 itself from the network service providing section 206, creates a path finding signaling packet with this service setting capability information appended thereto and transmits it to the routing apparatus 300 at the subsequent stage (step S102).

The routing apparatus 300 also performs the same processing as the routing apparatus 200, in which a path finding signaling packet with the service setting capability information of the routing apparatus 300 itself further appended is transmitted to the setting generation device 400 at the latter stage.

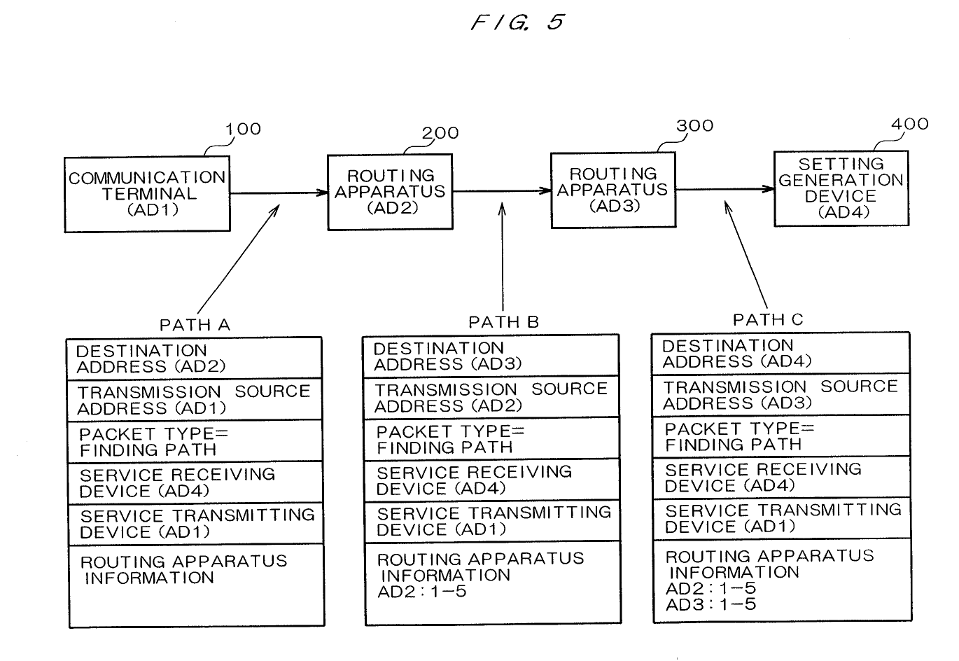

FIG. 5 is a block diagram showing the contents of the path finding signaling packet transmitted or received via the routing apparatuses 200, 300. In FIG. 5, “path A” denotes the path finding signaling packet transmitted from the communication terminal 100 to the routing apparatus 200, “path B” denotes the path finding signaling packet transmitted from the routing apparatus 200 to the routing apparatus 300, and “path C” denotes the path finding signaling packet transmitted from the routing apparatus 300 to the setting generation device 400. It is assumed herein that the addresses of the communication device 100, the routing apparatuses 200, 300 and the setting generation device 400 are AD1, AD2, AD3 and AD4, respectively.

As shown in FIG. 5, the path finding signaling packet (path A) transmitted from the communication terminal 100 to the routing apparatus 200 includes a destination address AD2 for designating the routing apparatus 200 that is the transmission destination of this packet and a transmission source address AD1 for designating the communication terminal 100 that is the transmission source of this packet.

Also, the path finding signaling packet (path B) transmitted from the routing apparatus 200 to the routing apparatus 300 includes a destination address AD3 for designating the routing apparatus 300 that is the transmission destination of this packet, a transmission source address AD2 for designating the routing apparatus 200 that is the transmission source of this packet, and the routing apparatus information as the service setting capability information appended in the routing apparatus 200. In an example as shown in FIG. 5, “AD2: 1-5”, indicating the delay time 1 though 5 m sec settable in the routing apparatus 200, is set as the routing apparatus information.

Also, the path finding signaling packet (path C) transmitted from the routing apparatus 300 to the setting generation device 400 includes a destination address AD4 for designating the setting generation device 400 that is the transmission destination of this packet, a transmission source address AD3 for designating the routing apparatus 300 that is the transmission source of this packet, and the routing apparatus information as the service setting capability information appended in the routing apparatus 300. In an example as shown in FIG. 5, the path finding signaling packet received from the routing apparatus 300 includes “AD2: 1-5” already set as the routing apparatus information, and “AD3: 1-5”, indicating the delay time 1 to 5 msec settable in the routing apparatus 300, which is further appended thereto.

Operation of Setting Generation Device

The operation of the setting generation device 400 that has received the path finding signaling packet will be described below.

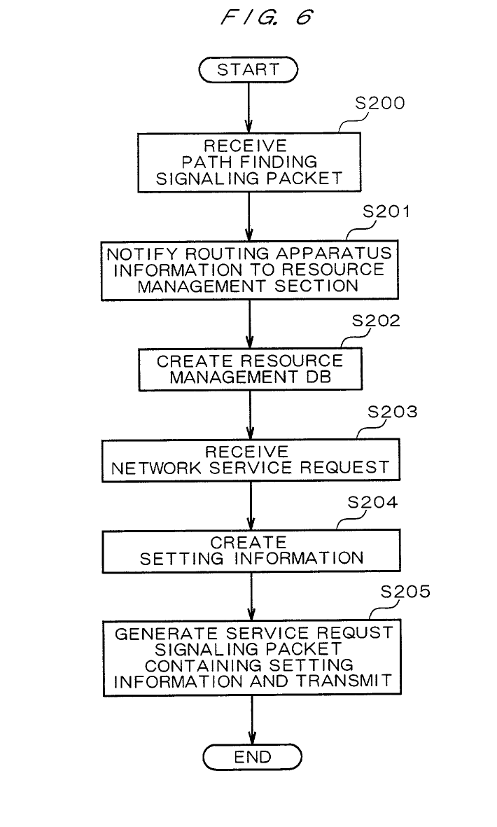

FIG. 6 is a flowchart showing the operation procedure of the setting generation device 400. The signaling processing section 402 within the setting generation device 400 receives a path finding signaling packet transmitted from the routing apparatus 300 (step S200), and then extracts the routing apparatus information contained in this packet and notifies it to the resource management section 404 (step S201).

Then, the resource management section 404 creates a resource management database (DB) on the basis of the routing apparatus information notified (step S202).

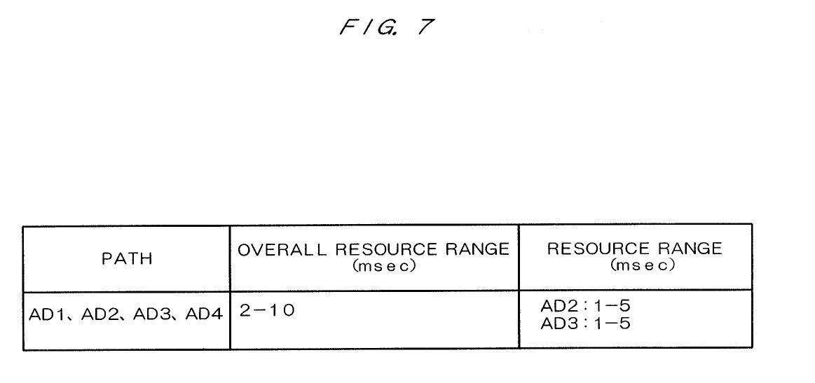

FIG. 7 is a table showing the contents of the resource management database. As shown in FIG. 7, the resource management database includes “path”, “overall resource range”, and “resource range”. The “path” is the communication path via each routing apparatus 200, 300 included in the routing apparatus information notified from the signaling processing section 402 to the resource management section 404. In an example as shown in FIG. 7, “AD1, AD2, AD3, AD4” are set as the path.

The “overall resource range” indicates the range of network service that can be provided via this communication path. In an example as shown in FIG. 7, supposing that the range of delay time that is settable in each routing apparatus 200, 300 is 1 through 5 msec, a total delay time range of “2 to 10 msec”, which is a summation of the delay time, is set as the overall resource range.

Also, the “resource range” indicates the range of delay time settable in each of two routing apparatuses 200, 300 included in this communication path. In this “resource range”, the contents of routing apparatus information notified from the signaling processing section 402 is directly set.

Then, the distribution setting information generation section 408 receives a network service request set in the request reception section 406 (step S203), and creates the setting information for each routing apparatus 200, 300 on the basis of the content of received network service request and the resource management database created by the resource management section 404 (step S204). Also, the signaling processing section 402 creates a service request signaling packet containing the setting information produced by the distribution setting information generation section 408, and transmits it to the routing apparatus 300 (step S205).

Operation of Routing Apparatus (at the Time of Setting the Network Service)

The operation of each routing apparatus 300, 200 that has received a service request signaling packet will be described below.

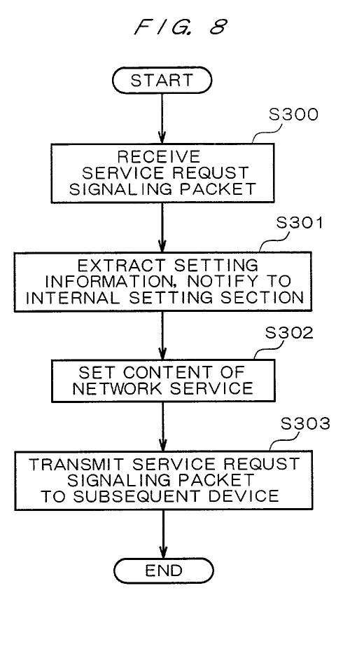

FIG. 8 is a flowchart showing the operation procedure of the routing apparatus 300 receiving the service request signaling packet. The signaling processing section 302 within the routing apparatus 300 receives the service request signaling packet (step S300), and then extracts the setting information contained in this packet and notifies it to the internal setting section 304 (step S301).

Then, the internal setting section 304 sets the content of network service provided by the network service providing section 206 on the basis of the setting information notified (step S302). Also, the signaling processing section 302 transmits the service request signaling packet to the routing apparatus 200 designated on the basis of the path information memorized in receiving the path finding signaling packet (step S303).

The routing apparatus 200 also performs the same processing as the routing apparatus 300 as described above, in which the content of network service provided by the network service providing section 206 within the routing apparatus 200 is set, and the service request signaling packet is transmitted to the communication terminal 100.

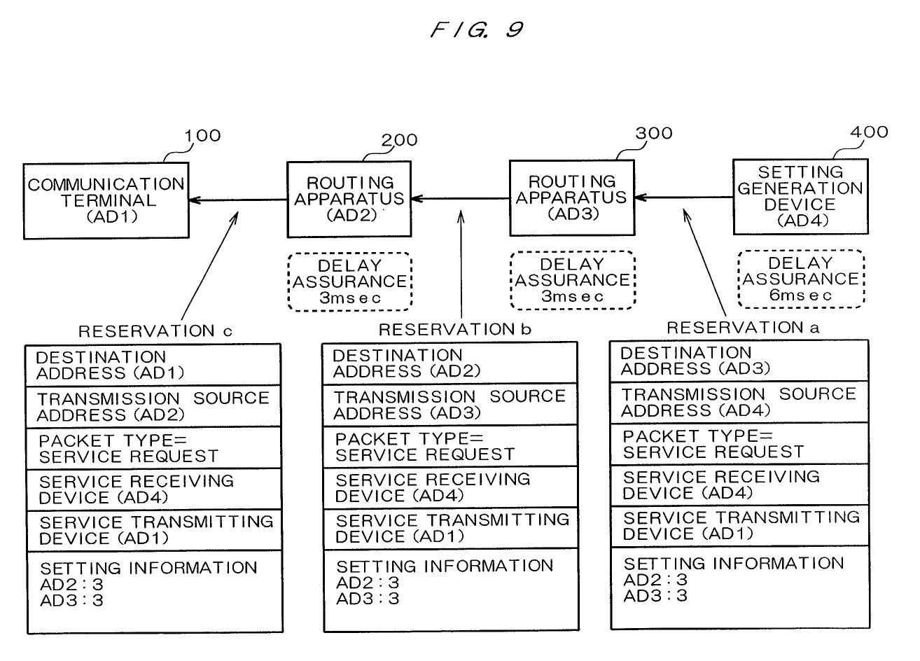

FIG. 9 is a block diagram showing the contents of the service request signaling packet transmitted or received via the routing apparatuses 300, 200, and the set content of network service in the routing apparatuses 300, 200. In FIG. 9, “reservation a” denotes the service request signaling packet transmitted from the setting generation device 400 to the routing apparatus 300, “reservation b” denotes the service request signaling packet transmitted from the routing apparatus 300 to the routing apparatus 200, and “reservation c” denotes the service request signaling packet transmitted from the routing apparatus 200 to the communication device 100, respectively. It is assumed herein that the delay time is set at 6 msec in the network service request received by the request reception section 406, and the content of network service provided in each of two routing apparatuses 300, 200 has a delay assurance of 3 msec set.

As shown in FIG. 9, the service request signaling packet (reservation a) transmitted from the setting generation device 400 to the routing apparatus 300 includes, as the setting information, a value of delay assurance “3 msec” for the routing apparatus 300 (address AD3) and a value of delay assurance “3 msec” for the routing apparatus 200 (address AD2). The internal setting section 304 within the routing apparatus 300 sets the content of network service provided in the network service providing section 306 to be “delay assurance of 3 msec”, on the basis of this setting information.

Similarly, the service request signaling packet (reservation b) transmitted from the routing apparatus 300 to the routing apparatus 200 includes, as the setting information, a value of delay assurance “3 msec” for the routing apparatus 300 and a value of delay assurance “3 msec” for the routing apparatus 200. The internal setting section 204 within the routing apparatus 200 sets the content of network service provided in the network service providing section 206 to be “delay assurance of 3 msec”, on the basis of this setting information.

Thereafter, if the service request signaling packet (reservation c) is transmitted from the routing apparatus 200 to the communication terminal 100, the signaling processing section 102 within the communication terminal 100 knows that the setting of the providing content of network service in each of the routing apparatuses 200, 300 included in the transfer path has been ended, and the internal setting section 104 instructs the network service providing section 106 to start the service. The network service providing section 106 starts the packet communication to the setting generation device 400 that is the communication partner in accordance with this instruction.

In this way, the packet transmitted from the communication terminal 100 is transferred by each routing apparatus 200, 300. At the time of transfer, a delay assurance of 3 msec is provided in each routing apparatus 200, 300, whereby a delay assurance of 6 msec in total is provided in the communication from the communication terminal 100 to the setting generation device 400.

Thus, the setting generation device 400 collects synthetically the information (routing apparatus information) regarding the service setting capability of each routing apparatus 200, 300, and generates individual setting information required to meet the network service request. Accordingly, the network service request can be met in the communication from the communication terminal 100 to the setting generation device 400 by each routing apparatus 200, 300 making the setting on the basis of this setting information.

In the above embodiment, the setting generation device 400 is employed as the communication terminal that is the communication partner of the communication terminal 100. However, the function of the communication terminal as the communication partner and the function of the setting generation device 400 may be separated. That is, the setting generation device 400 may be installed at any site so far as it can collect the information of each routing apparatus 200, 300. For example, the function of the setting generation device 400 may be included within the routing apparatus 200 or 300, or the function of the setting generation device 400 may be included in some other device connected outside the communication path.

Also, in the above embodiment, each communication device communicates in accordance with the signaling protocol. However, other protocols, including telnet, COPS (Common Open Policy Service), LDAP (Lightweight Directory Access Protocol ), SNMP (Simple Network Management Protocol), may be employed.

Also, in the above embodiment, the resource management database is held within the resource management section 404 of the setting generation device 400 that collects the information of each routing apparatus 200, 300. However, the resource management database may be held in the external device, and read in accordance with a protocol such as LDAP, at every time as required.

Also, in the above embodiment, the network comprises two routing apparatuses 200, 300. However, three or more routing apparatuses may be employed in the network.

[Second Embodiment]

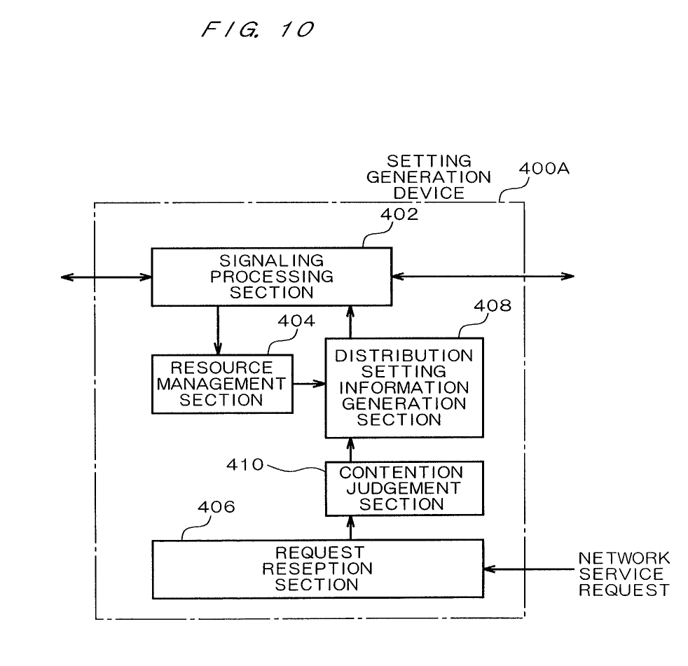

FIG. 10 is a block diagram showing the configuration of a setting generation device 400A included in a network according to a second embodiment of the invention. The setting generation device 400A of this embodiment is the same as that of the first embodiment as shown in FIG. 3, except that a contention judgement section 410 is added to the setting generation device 400 of the first embodiment. Other configuration within the setting generation device 400A and the network configuration (communication terminal 100 and routing apparatuses 200, 300) except for the setting generation device 400A are the same as those of the first embodiment, and the different points will only be noted and described below.

The contention judgement section 410 within the setting generation device 400A judges whether or not a network service request is accepted on the basis of a stored rule. For example, in this embodiment, a rule of “two or more services are not provided in the same communication path” is stored in the contention judgement section 410.

If a network service request is received by the request reception section 406, the contention judgement section 410 judges whether or not the network service request is against the stored rule. If not against the rule, the request reception section 406 holds this request information in accordance with the rule, and notifies a network service request received by the request reception section 406 to the distribution setting information generation section 408. The ensuing operation of the setting generation device 400A is the same as that of the setting generation device 400 as shown in FIG. 3, in which the value of delay assurance is set to 3 msec by the routing apparatuses 300, 200 receiving the service request signaling packet containing the setting information generated by the distribution setting information generation section 408 so as to meet the network service request (e.g., the delay over the entire communication path is 6 msec).

On the other hand, if the network service request is against the rule, no network service request is notified to the distribution setting information generation section 408. In this case, the service request signaling packet containing the information that communication meeting the request is impossible is transmitted from the signaling processing section 402 to the communication terminal 100.

In this way, in this embodiment, the contention judgement section 410 judges whether or not the content of network service request is against the content of the stored rule. For the network service request against the rule, the setting of each routing apparatus 200, 300 is not performed. Therefore, since a plurality of communications may contend on the same communication path, it is possible to avoid a situation where the network service request cannot be met.

In the above embodiment, the contention judgement section 410 stores the rule of “two or more services are not provided on the same communication path”. However, it may make the judgement based on other rule.

[Third Embodiment]

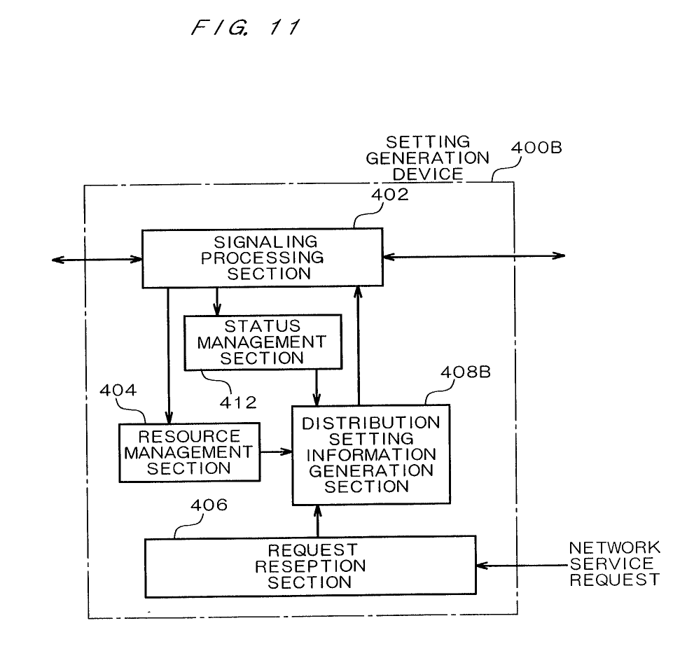

FIG. 11 is a block diagram showing the configuration of a setting generation device 400B included in a network according to a third embodiment of the invention. The setting generation device 400B of this embodiment is the same as that of the first embodiment as shown in FIG. 3, except that a status management section 412 is added to the setting generation device 400 of the first embodiment, and the distribution setting information generation section 408 is changed to a distribution setting information generation section 408B. Other configuration within the setting generation device 400B and the network configuration (communication terminal 100 and routing apparatuses 200, 300) except for the setting generation device 400B are the same as those of the first embodiment, and the different points will only be noted and described below.

In this embodiment, each of the routing apparatuses 200, 300 creates a path finding signaling packet with the routing apparatus information containing the load state information added, and transmits it to the device at the subsequent stage.

The status management section 412 within the setting generation device 400B is notified of the routing apparatus information within the path finding signaling packet from the signaling processing section 402 to extract each load state information of the routing apparatuses 200, 300 from this routing apparatus information and create a status management database.

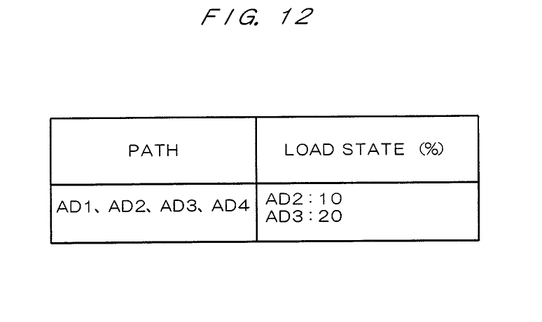

FIG. 12 is table showing the contents of the status management database. As shown in FIG. 12, the status management database includes “path” and “load state”. The “path” is a communication path via each routing apparatus 200, 300 contained in the routing apparatus information notified from the signaling processing section 402 to the status management section 412. The “load state” indicates the load state of each routing apparatus 200, 300. In this “load state”, the content of routing apparatus information notified from the signaling processing section 402 is directly set. For instance, in an example as shown in FIG. 12, the load state of the routing apparatus 200 (address AD2) and the routing apparatus 300 (address AD3) is indicated with the use ratio (%) of a queue storing the transfer packet. A larger value of the load state means a higher use ratio of queue, or means that it is necessary to suppress the use ratio of queue available in the new communication, in which a short delay assurance must be set for such routing apparatus. On the contrary, a smaller value of the load state means a lower use ratio of queue, or means that it is possible to increase the use ratio of queue available in the new communication, in which a long delay assurance can be set for such routing apparatus.

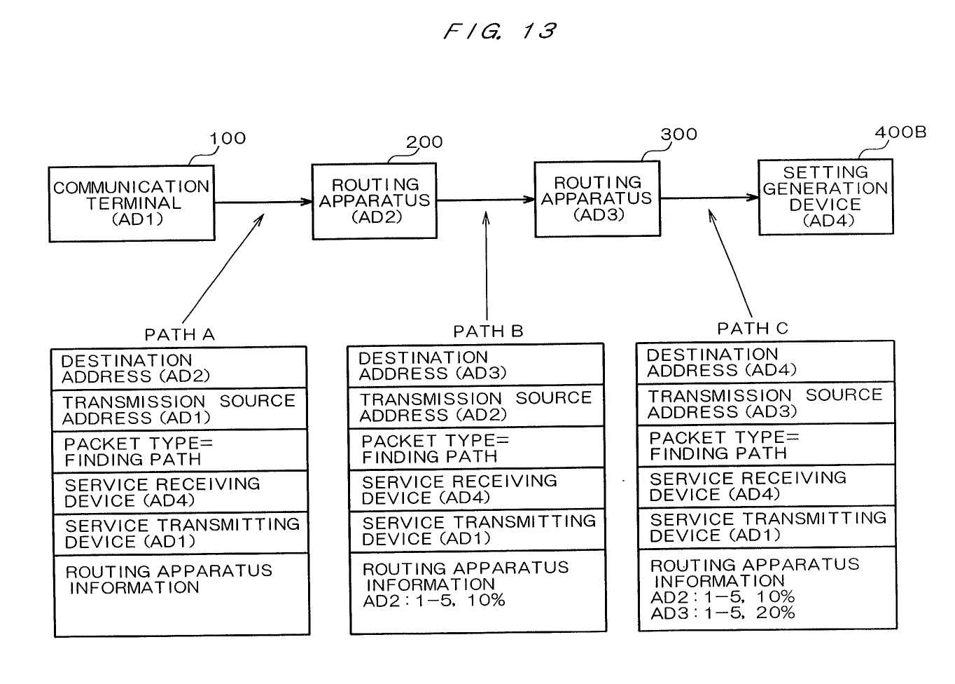

FIG. 13 is a diagram showing the contents of the path finding signaling packet transmitted or received via the routing apparatuses 200 and 300. As shown in FIG. 13, the path finding signaling packet (path A) transmitted from the communication terminal 100 to the routing apparatus 200 includes a destination address AD2 for designating the routing apparatus 200 that is the transmission destination of this packet and a transmission source address AD1 for designating the communication terminal 100 that is the transmission source of this packet.

Also, the path finding signaling packet (path B) transmitted from the routing apparatus 200 to the routing apparatus 300 includes a destination address AD3 for designating the routing apparatus 300 that is the transmission destination of this packet, a transmission source address AD2 for designating the routing apparatus 200 that is the transmission source of this packet, and additionally the routing apparatus information including the service setting capability information and the load state information of the routing apparatus 200. In an example as shown in FIG. 5, “AD2: 1-5”, indicating a delay time of 1 through 5 msec settable in the routing apparatus 200, is set as the service setting capability information, and “10%” indicating the use ratio of queue within the routing apparatus 200 is set as the load state information.

Also, the path finding signaling packet (path C) transmitted from the routing apparatus 300 to the setting generation device 400 includes a destination address AD4 for designating the setting generation device 400 that is the transmission destination of this packet, a transmission source address AD3 for designating the routing apparatus 300 that is the transmission source of this packet, and the routing apparatus information as the service setting capability information “AD3: 1-5” and the load state information “20%” of the routing apparatus 300 appended in the routing apparatus information.

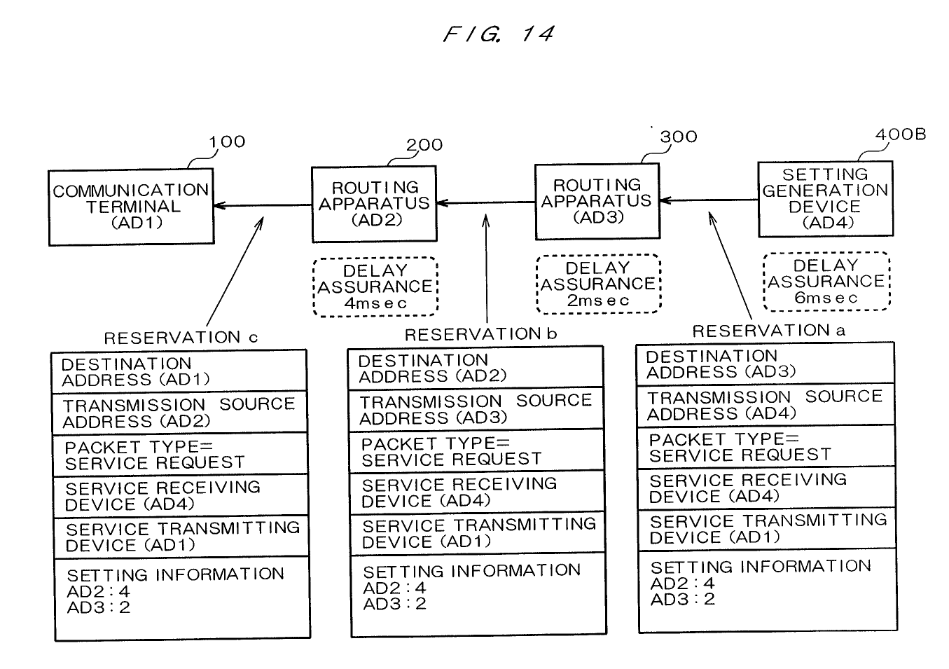

FIG. 14 is a block diagram showing the contents of the service request signaling packet transmitted or received via the routing apparatuses 300, 200, and the set content of network service in the routing apparatuses 300, 200. In FIG. 14, “reservation a” denotes the service request signaling packet transmitted from the setting generation device 400B to the routing apparatus 300, “reservation b” denotes the service request signaling packet transmitted from the routing apparatus 300 to the routing apparatus 200, and “reservation c” denotes the service request signaling packet transmitted from the routing apparatus 200 to the communication terminal 100, respectively. It is assumed herein that the delay time is set at 6 msec in the network service request received by the request reception section 406. Consider a case where the value of delay assurance in the routing apparatus 200 with a load state of 10% is set to “4 msec” and the value of delay assurance in the routing apparatus 300 with a load state of 20% is set to “2 msec”.

As shown in FIG. 14, the service request signaling packet (reservation a) transmitted from the setting generation device 400B to the routing apparatus 300 includes, as the setting information, a value of delay assurance “2 msec” for the routing apparatus 300 (address AD3) and a value of delay assurance “4 msec” for the routing apparatus 200 (address AD2). The internal setting section 304 within the routing apparatus 300 has the content of network service provided in the network service providing section 306, which is set to “delay assurance of 2 msec”, on the basis of this setting information.

Similarly, the service request signaling packet (reservation b) transmitted from the routing apparatus 300 to the routing apparatus 200 includes, as the setting information, a value of delay assurance “2 msec” for the routing apparatus 300 and a value of delay assurance “4 msec” for the routing apparatus 200. The internal setting section 204 within the routing apparatus 200 has the content of network service provided in the network service providing section 206, which is set to “delay assurance of 4 msec”, on the basis of this setting information.

Thereafter, if the service request signaling packet (reservation c) is transmitted from the routing apparatus 200 to the communication terminal 100, the signaling processing section 102 within the communication terminal 100 knows that the setting of the providing content of network service in each of the routing apparatuses 200, 300 included in the transfer path has been ended, and the internal setting section 104 instructs the network service providing section 106 to start the service. The network service providing section 106 starts the packet communication to the setting generation device 400 that is the communication partner in accordance with this instruction.

In this way, in this embodiment, in creating the setting information corresponding to each of the routing apparatuses 200, 300 in the setting generation device 400B, the load state of each routing apparatus is considered, and the content of network service can be set so that the service state of network resource for each routing apparatus may be more uniform. Therefore, it is possible to make effective use of the network resources.

[Fourth Embodiment]

In the first through third embodiments as set forth above, the communication device that has received the path finding signaling packet and sends back the service request signaling packet functions as the setting generation device 400. However, the communication terminal that transmits the path finding signaling packet may be provided with the function of the setting generation device.

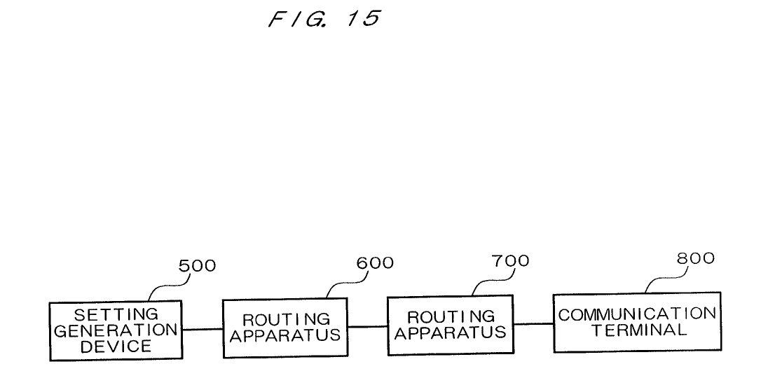

FIG. 15 is a block diagram showing the configuration of a network according to a fourth embodiment of the invention. The network of this embodiment as shown in FIG. 15 comprises a setting generation device 500, the routing apparatuses 600, 700, and a communication terminal 800.

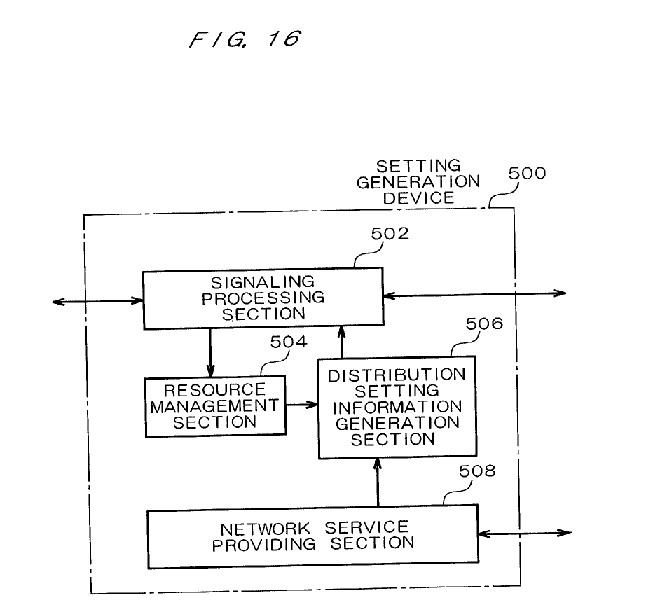

FIG. 16 is a block diagram showing the schematic configuration of the setting generation device 500. As shown in FIG. 16, the setting generation device 500 comprises a signaling processing section 502, a resource management section 504, a distribution setting information generation section 506, and a network service providing section 508. This setting generation device 500, like the setting generation device 400 of the first embodiment, has the function of the communication terminal to effect transmission or reception of the packet to or from the communication terminal 800.

The signaling processing section 502 performs the signaling processing employing an RSVP message. Specifically, the signaling processing section 502 creates a path finding signaling packet and transmits it to a routing apparatus 600 at the subsequent stage, and receives a service request signaling packet, which is transmitted from the routing apparatus 600, and sends out the path finding signaling packet containing the setting information (hereinafter described) to a routing apparatus 700 again. The signaling processing section 502 operates as an information collection section for receiving various kinds of information sent from each of the routing apparatuses 600 and 700, and as a setting information transmission section for notifying the setting information to each of the routing apparatuses 600 and 700.

The resource management section 504 collects the information of each routing apparatus 600, 700 contained in the service request signaling packet received by the signaling processing section 502, and synthetically manages the network resources for each routing apparatus 600, 700.

The distribution setting information generation section 506 creates the setting information regarding the network resources for each routing apparatus 600, 700 required to implement the requested network service, on the basis of the information regarding the network resources of each routing apparatus 600, 700 collected by the resource management section 504.

The network service providing section 508 provides a predetermined network service. For example, the network service providing section 508 transmits or receives the packet to or from a communication terminal 800, employing the setting generation device 500 as the communication terminal.

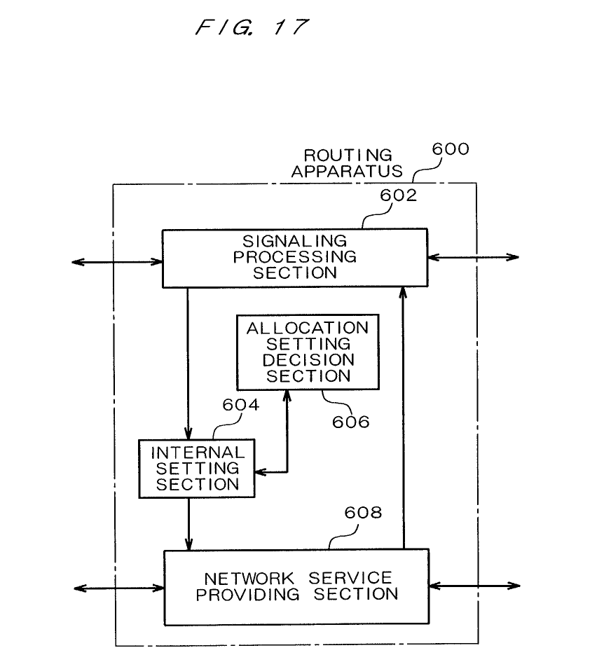

FIG. 17 is a block diagram showing the schematic configuration of the routing apparatus 600. As shown in FIG. 17, the routing apparatus 600 comprises a signaling processing section 602, an internal setting section 604, an allocation setting decision section 606, and a network service providing section 608.

The signaling processing section 602 performs the signaling processing employing an RSVP message. Specifically, the signaling processing section 602 transmits a path finding signaling packet to determine a route through which a network service is provided. Also, the signaling processing section 602 receives a service request signaling packet sent back corresponding to the path finding signaling packet. The signaling processing section 602 operates as an information transfer section to notify the resource information and function information provided in the routing apparatus 600 and the information for providing the network service that the routing apparatus 600 performs, to the outside.

The internal setting section 604 sets the contents of a network service to be provided in the network service providing section 608, when a service request signaling packet containing the request information or a path finding signaling packet containing the setting information is received by the signaling processing section 602. The allocation setting decision section 606 decides the set consents of the internal setting section 604 in accordance with a stored rule. The allocation setting decision section 606 corresponds to a preliminary setting section.

The network service providing section 608 provides the network service with the set contents, upon an instruction from the internal setting section 604. For example, the value of delay assurance or the communication band when transmitting or receiving the packet via this routing apparatus 600 can be set by the network service providing section 608.

The routing apparatus 700 (signaling processing section 702, internal setting section 704, allocation setting decision section 706, network service providing section 708) has fundamentally the same configuration, in which like parts are designated by the same or like reference numerals or signs, and not described in detail.

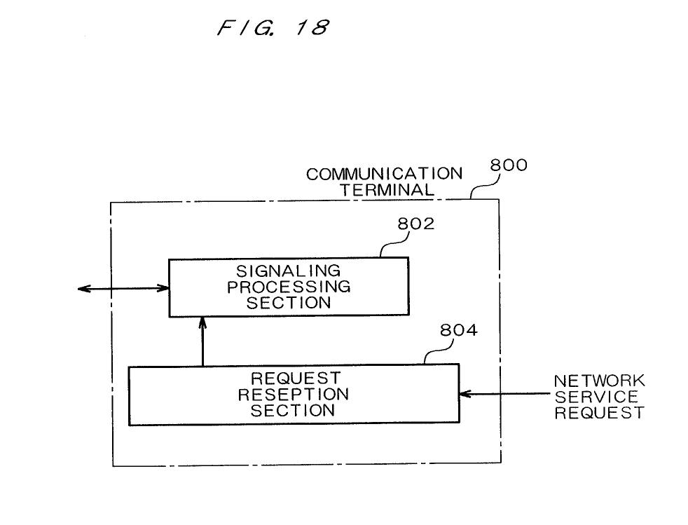

FIG. 18 is a block diagram showing the schematic configuration of the communication terminal 800. As shown in FIG. 18, the communication terminal 800 comprises a signaling processing section 802 and a request reception section 804.

The signaling processing section 802 performs the signaling processing employing an RSVP message. Specifically, the signaling processing section 802 sends out a service request signaling packet containing the request information (hereinafter described) to the routing apparatus 700, when receiving a path finding signaling packet from the signaling processing section 702 within the routing apparatus 700.

The request reception section 804 accepts a network service request corresponding to the packet communication between the setting generation device 500 and the communication terminal 800. This network service request is either transmitted from the outside or stored beforehand in the request reception section 804.

The setting generation device 500, the routing apparatuses 600, 700 and the communication terminal 800 of this embodiment have the above configuration, and the operation will be described below.

Operation of Routing Apparatus (at the Time of Routing)

The setting generation device 500 for transmitting the data intended to provide a network service creates a path finding signaling packet in the signaling processing section 502, and transmits it to the routing apparatus 600 at the next stage.

The signaling processing section 602 within the routing apparatus 600 receives the path finding signaling packet, and then memorizes a network device (setting generation device 500) corresponding to a transmission source address contained in this packet as a part of the route information, and creates a path finding signaling packet with the destination address and the transmission source address changed to transmit it to the routing apparatus 700 at the next stage.

The routing apparatus 700 that makes the same processing as the routing apparatus 600 transmits the path finding signaling packet to the communication terminal 800.

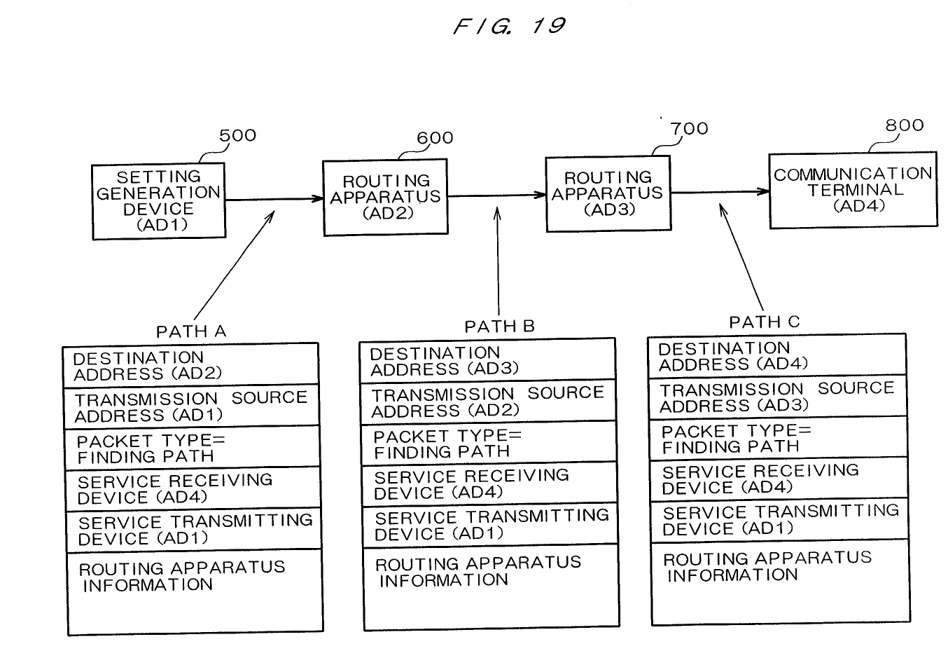

FIG. 19 is a block diagram showing the contents of the path finding signaling packet transmitted or received via the routing apparatuses 600, 700 at the time of routing. In FIG. 19, “path A” denotes the path finding signaling packet transmitted from the setting generation device 500 to the routing apparatus 600, “path B” denotes the path finding signaling packet transmitted from the routing apparatus 600 to the routing apparatus 700, and “path C” denotes the path finding signaling packet transmitted from the routing apparatus 700 to the communication terminal 800, respectively. In FIG. 19, it is assumed herein that the addresses of the setting generation device 500, the routing apparatuses 600, 700 and the communication terminal 800 are AD1, AD2, AD3 and AD4, respectively.

As shown in FIG. 19, the path finding signaling packet (path A) transmitted from the setting generation device 500 to the routing apparatus 600 includes a destination address AD2 for designating the routing apparatus 600 that is the transmission destination of this packet and a transmission source address AD1 for designating the setting generation device 500 that is the transmission source of this packet.

Also, the path finding signaling packet (pathB) transmitted from the routing apparatus 600 to the routing apparatus 700 includes a destination address AD3 for designating the routing apparatus 700 that is the transmission destination of this packet, and a transmission source address AD2 for designating the routing apparatus 600 that is the transmission source of this packet. Though in the first embodiment, this path finding signaling packet includes the routing apparatus information as the service setting capability information appended in the routing apparatus 600, but the path finding signaling packet does not include the service setting capability information in this embodiment.

Also, the path finding signaling packet (path C) transmitted from the routing apparatus 700 to the communication terminal 800 includes a destination address AD4 for designating the communication terminal 800 that is the transmission destination of this packet, and a transmission source address AD3 for designating the routing apparatus 700 that is the transmission source of this packet.

Operation of Communication Terminal

The communication terminal 800 receives a path finding signaling packet sent from the routing apparatus 700 in the signaling processing section 802, and receives a network service request input from the outside in the request reception section 804. For example, a network service request of suppressing the delay in the communication from the setting generation device 500 to the communication terminal 800 to 4 msec is entered. This network service request is notified to the signaling processing section 802.

Then, the signaling processing section 802 creates a service request signaling packet containing as the request information the content of network service request “delay: 4 msec” notified from the request reception section 804, and transmits it to the routing apparatus 700.

Operation of Routing Apparatus (at the Reception Time of Service Request Signaling Packet)

The signaling processing section 702 within the routing apparatus 700 receives the service request signaling packet sent from the communication terminal 800, and then extracts the request information contained in this packet and notifies it to the internal setting section 704. Then, the internal setting section 704 makes a predetermined notification containing this request information to the allocation setting decision section 706. The allocation setting decision section 706 receiving this notification decides the set contents in the internal setting section 704 in accordance with the stored rule. For example, in this embodiment, supposing that a rule of “making the delay minimum” is stored beforehand in the allocation setting decision section 706, the set value of delay is set to a minimum of 1 msec. Then, the internal setting section 704 sets the content of network service provided by the network service providing section 708 so as to have the set content (1 msec) decided by the allocation setting decision section 706.

Also, the signaling processing section 702 creates a service request signaling packet with the updated request information and transmits it to the routing apparatus 600. A service request signaling packet with the updated content “delay: 3 msec”, which is equal to the content of request information “delay: 4 msec” contained in service request signaling packet sent from the communication terminal 800 subtracted by the content “delay: 1 msec” set in the routing apparatus 700, is created.

The routing apparatus 600 makes the same processing as the routing apparatus 700, in which the delay in the network service providing section 608 is set to a minimum of 1 msec by the internal setting section 604, and a service request signaling packet with the request information updated to “2 msec” is transmitted to the setting generation device 500.

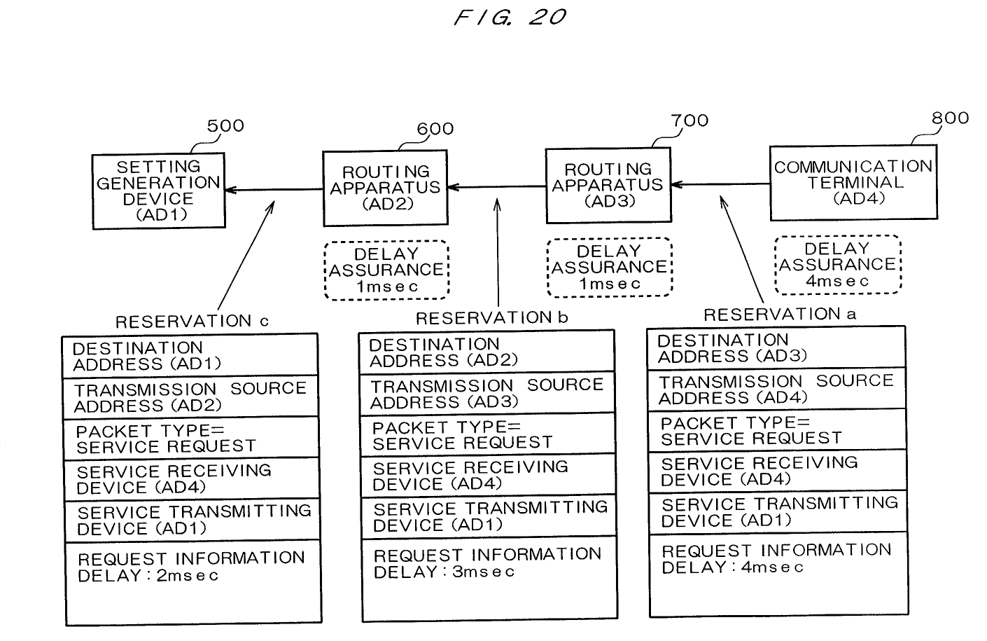

FIG. 20 is a block diagram showing the contents of the service request signaling packet transmitted or received via the routing apparatuses 700, 600 and the set content of network service in the routing apparatuses 700, 600. In FIG. 20, “reservation a” denotes the service request signaling packet transmitted from the communication terminal 800 to the routing apparatus 700, “reservation b” denotes the service request signaling packet transmitted from the routing apparatus 700 to the routing apparatus 600, and “reservation c” denotes the service request signaling packet transmitted from the routing apparatus 600 to the setting generation device 500, respectively. It is assumed herein that the delay time is set at 4 msec in the network service request received by the request reception section 804 within the communication terminal 800.

As shown in FIG. 20, the service request signaling packet (reservation a) transmitted from the communication terminal 800 to the routing apparatus 700 includes “delay: 4 msec” as the request information. The allocation setting decision section 706 and the internal setting section 704 within the routing apparatus 700 set the content of network service provided in the network service providing section 708 to be “delay assurance 1 msec”.

Similarly, the service request signaling packet (reservation b) transmitted from the routing apparatus 700 to the routing apparatus 600 includes “delay: 3 msec” as the request information. The allocation setting decision section 606 and the internal setting section 604 within the routing apparatus 600 set the content of network service provided in the network service providing section 608 to be “delay assurance 1 msec”.

Thereafter, the service request signaling packet (reservation c) containing “delay: 2 msec” as the request information is transmitted from the routing apparatus 600 to the setting generation device 500.

Operation of Setting Generation Device

The signaling processing section 502 within the setting generation device 500 receives a service request signaling packet transmitted from the routing apparatus 600, and instructs the network service providing section 508 to start the service, knowing that setting of the providing contents of the network service with the routing apparatuses 600, 700 has been ended. The network service providing section 508 starts the packet communication to the communication terminal 800 that is the communication partner in accordance with this instruction.

In parallel with the start operation of this service, the resource management section 504 acquires the information regarding the transfer path on the basis of the service request signaling packet received by the signaling processing section 502, and stores and manages the request information “2 msec” left behind ultimately on this transfer path in the resource management database.

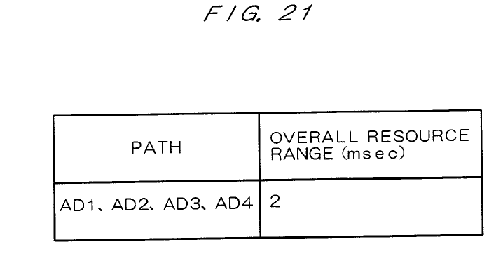

FIG. 21 is a table showing the contents of the resource management database. As shown in FIG. 21, the resource management database includes “path” and “overall resource range”. The “path” is the communication path via each routing apparatus 700, 600. In the “overall resource range”, a value of request information “2 msec” included in the service request signaling packet received by the signaling processing section 502 is directly set.

Also, resource management section 504 notifies the overall resource range “2 msec” included in the resource management database to the distribution setting information generation section 506. Receiving this notification, the distribution setting information generation section 506 decides the setting information for distributing the resource to each routing apparatus 600, 700. In this embodiment, the setting information “extra delay: 2 msec” of resource in which the value of overall resource range “2 msec” is directly distributed to each routing apparatus 600, 700 is set.

Thereafter, the signaling processing section 502 creates a path finding signaling packet containing this setting information, and transmits it to the routing apparatus 600.

Operation of Routing Apparatus (at the Reception Time of Path Finding Signaling Packet Containing the Setting Information)

The signaling processing section 602 within the routing apparatus 600 receives a path finding signaling packet transmitted from the setting generation device 500, and then extracts the setting information contained in this packet and notifies it to the internal setting section 604. Then, the internal setting section 604 makes a predetermined notification containing this setting information to the allocation setting decision section 606. The allocation setting decision section 606 receiving this notification decides the set contents in the internal setting section 604 in accordance with the stored rule. As described above, in this embodiment, supposing that a rule of “making the delay minimum” is stored beforehand in the allocation setting decision section 606, the delay time is set at 2 msec by adding a minimum delay time of 1 msec to the delay time of 1 msec already set. Then, the internal setting section 604 sets the content of network service provided by the network service providing section 608 so as to have the setting content (2 msec) decided by the allocation setting decision section 606.

Also, the signaling processing section 602 creates a path finding signaling packet with the updated setting information and transmits it to the routing apparatus 700. A service request signaling packet with the updated content “extra delay: 1 msec”, which is equal to the content of setting information “extra delay: 2 msec” contained in path finding signaling packet sent from the setting generation device 500 subtracted by the amount “1 msec” consumed in the routing apparatus 600, is created.

The routing apparatus 700 also makes the same processing as the routing apparatus 600, in which the delay in the network service providing section 708 is set to 2 msec by the internal setting section 704, and a path finding signaling packet with the setting information updated to “0 msec” is transmitted to the communication terminal 800.

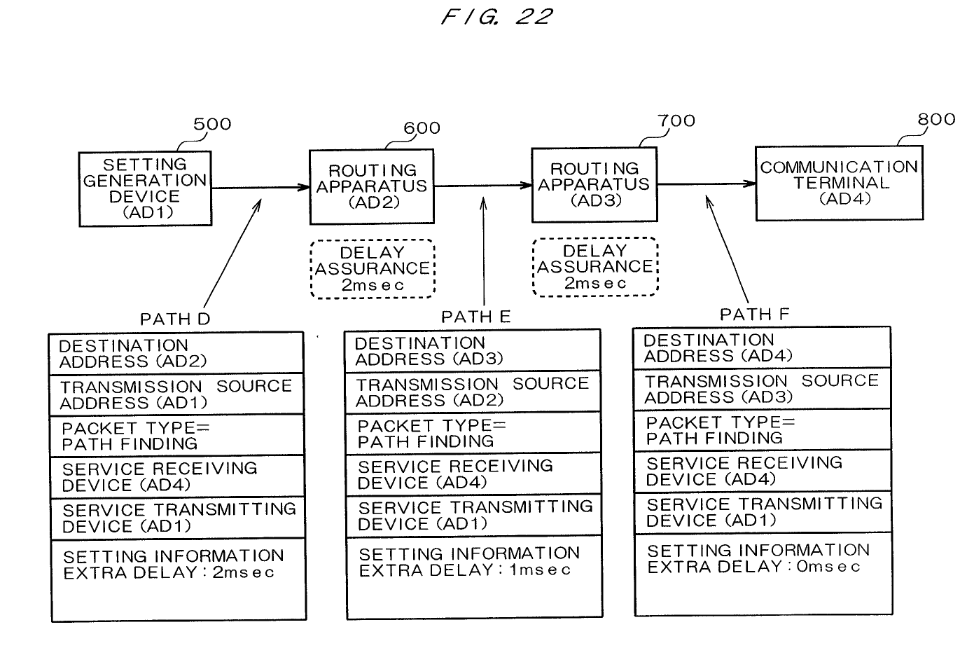

FIG. 22 is a block diagram showing the contents of the path finding signaling packet transmitted or received via the routing apparatuses 600, 700, and the set content of network service in the routing apparatuses 600, 700. In FIG. 22, “path D” denotes the path finding signaling packet transmitted from the setting generation device 500 to the routing apparatus 600, “path E” denotes the path finding signaling packet transmitted from the routing apparatus 600 to the routing apparatus 700, and “path F” denotes the path finding signaling packet transmitted from the routing apparatus 700 to the communication terminal 800.

As shown in FIG. 22, the path finding signaling packet (path D) transmitted from the setting generation device 500 to the routing apparatus 600 includes “extra delay: 2 msec” as the setting information. The allocation setting decision section 606 and the internal setting section 604 within the routing apparatus 600 set the content of network service provided in the network service providing section 608 to be “delay assurance 2 msec”.

Similarly, the path finding signaling packet (path E) transmitted from the routing apparatus 600 to the routing apparatus 700 includes “extra delay: 1 msec” as the setting information. The allocation setting decision section 706 and the internal setting section 704 within the routing apparatus 700 set the content of network service provided in the network service providing section 708 to be “delay assurance 2 msec”.

Thereafter, the path finding signaling packet (path F) containing “extra delay: 0 msec” as the setting information is transmitted from the routing apparatus 700 to the communication terminal 800.

In this way, in this embodiment, the delay assurance in each routing apparatus 600, 700 is set on the basis of the request information contained in the service request signaling packet or the setting information contained in the path finding signaling packet. Thereby, the network service request can be met in the communication from the setting generation device 500 to the communication terminal 800.

1. A network service setting system, comprising:
a communication device having a network resource for providing a predetermined network service in making a communication via a network; and
a setting generation device for setting a service condition of said network resource contained in said communication device so that said network service corresponding to the whole communication path intended for said communication meets a predetermined request.

2. The network service setting system according to claim 1, in which said communication device is a routing apparatus connecting between terminal devices for transmitting or receiving the data in said communication,
wherein said routing apparatus comprises:
an information transfer section for notifying its own resource information to said setting generation device; and
a network service providing section for providing a network service of the content based on the setting information passed from said setting generation device.

3. The network service setting system according to claim 2, wherein said setting generation device comprises:
an information collection section for collecting said resource information passed from said routing apparatus;
a setting information generation section for generating said setting information on the basis of said resource information corresponding to a plurality of routing apparatuses which said information collection section collects; and
a setting information transmission section for transmitting said setting information generated by said setting information generation section to said routing apparatuses.

4. The network service setting system according to claim 3, wherein said setting generation device further comprises a contention judgement section for judging the contention of request in accordance with a predetermined rule.

5. The network service setting system according to claim 3, wherein said setting generation device further comprises a load management section for managing the load state of said routing apparatus, and said setting information generation section generates said setting information in consideration of said load state managed by said load management section.

6. The network service setting system according to claim 2, wherein said routing apparatus further comprises a preliminary setting section for making the preliminary setting of the contents of network service, before setting the contents of said network service on the basis of said setting information passed from said setting generation device, and said network service providing section starts said network service in accordance with the contents of said preliminary setting.

7. The network service setting system according to claim 2, wherein said information transfer section is a signaling processing section for transmitting and receiving a signaling packet in accordance with a resource reservation protocol, and the notification of said resource information is made employing a path message.

8. The network service setting system according to claim 3, wherein said setting information transmission section is a signaling processing section for transmitting and receiving the signaling packet in accordance with the resource reservation protocol, and said setting information is transmitted employing a reservation message.

9. A network service providing method for providing a predetermined network service in making a communication via a network, comprising:
a first step of enabling a setting generation device to set up the service condition of a network resource contained in individual communication device so that said network service corresponding to the whole communication path intended for said communication meets a predetermined request; and
a second step of providing said predetermined network service in said individual communication device with the service condition of said network resource set up at said first step.

10. The network service providing method according to claim 9, further comprising a third step of enabling said individual communication device to notify its own resource information to said setting generation device, before said first step.

11. The network service providing method according to claim 9, wherein the service condition of said network resource at the first step is set up in consideration of the load state of said individual communication device.

12. A communication service for providing a network service in which the whole communication path using a plurality of communication devices can meet a predetermined request by collecting and managing synthetically the information of network resources which individual communication devices have.
